(19) United States
(12) Patent Application Publication
(10) Pub. No.: US 2007/0089945 A1
(43) Pub. Date: Apr. 26, 2007

(54) Closure device particularly for a sports shoe

(75) Inventor: Daniele Martignago, Maser (IT)

Correspondence Address: MODIANO & ASSOCIATI, Via Meravigli, 16, MILAN, 20123, IT

(73) Assignee: EMMEPI S.R.L.

(21) Appl. No.: 11/545,565

(22) Filed: Oct. 11, 2006

(30) Foreign Application Priority Data
Oct. 25, 2005 (IT) TV2005U000053

(51) Int. Cl. F16D 51/00

(52) U.S. Cl. 188/79.54

(57) ABSTRACT

A closure device for a sports shoe, comprising a toothed band, rigidly coupleable to a first flap of the shoe and associatable slidingly with a base rigidly coupleable to a second flap of the shoe. The base comprises a first pawl-shaped element having a first tip suitable to engage selectively the toothed band to prevent its extraction in an opening direction of the shoe flaps. The free ends of the arms of a U-shaped lever are rotatably associated with the base at first pivots. A second pawl-shaped element is provided supported rotatably between the arms at a second pivot, axially offset with respect to the first pivots toward the toothed band. The second pawl-shaped element is provided with a second tip which can engage the toothed band.

The present invention relates to a closure device particularly for a sports shoe, such as for example a ski boot, a cycling shoe, a roller skate or an ice skate.

### BACKGROUND OF THE INVENTION

Currently, two flaps of a sports shoe are mutually fastened by using closure devices which comprise a toothed band, which can be fixed to one of said flaps and is associable with a base which can be fixed to the other flap.

Means for taking up the useful length of the band and a pawl-shaped element are further associated with the base; such pawl-shaped element is provided with an end which can engage selectively the teeth of said band in order to contrast its backward motion.

In a first known type, said means for taking up the useful length of the band are constituted by a lever, which is associated rotatably with the base with one of its ends which has a toothed surface.

By causing the lever to oscillate repeatedly, in contrast with the action of suitable elastic means, the toothed surface of said lever engages alternately the various teeth of the band, making it advance with respect to the base and thus allowing to reach the chosen degree of mutual fastening of the flaps.

The main drawback of these known types of closure device is that during the oscillation of the lever, the tip of the teeth of said lever slides on the teeth of the band with a variable angle of incidence, and therefore, as use continues, may scratch and/or wear said teeth, with the risk of compromising the correct traction of the band.

Another drawback of known types is that since the band, due to the structure of the shoe and/or to the presence of the foot of the user, is subjected to a tension which tends to make it retract with respect to the base, when the pawl-shaped element is released the band retracts immediately, causing a consequent uncontrolled reduction of the mutual fastening of the flaps; therefore, it is not possible to reduce selectively the degree of fastening of the flaps, unless subsequent readjustments thereof are performed by releasing and causing the advancement of the band repeatedly until the chosen degree of fastening is achieved.

As a partial solution to this second drawback, closure devices are known which comprise two pawl-shaped elements, which have a reduced width, are arranged mutually side by side and are kept pressed toward the band by two mutually independent elastic means; one of the two pawl-shaped elements, moreover, is longer than the other by an extent approximately equal to half of a tooth of the band.

The retraction of the band is thus prevented by the engagement of one of said pawl-shaped elements with a tooth of said band; by releasing said pawl-shaped element, the band retracts by a distance which is equal to approximately half a tooth, and then the band is locked again by the other pawl-shaped element; in this manner, it is possible to achieve the retraction of the band by half a tooth at the time even while the shoe is being used.

However, this known solution still has the drawback of the possible wear of the teeth of the band by the teeth of the lever; further, it has the additional disadvantage that the dimensions of the pawl-shaped elements are very small and therefore said elements do not ensure reliable locking of the band and are more subject to wear and/or breakage with respect to a single pawl-shaped element having larger dimensions.

Further, said closure device is structurally complicated and has high production costs.

A different known type of device for closing the two flaps of a shoe comprises again a toothed band, which can be fixed to one of said flaps and is associable with a base which can be fixed to the other flap.

A lever is associated rotatably with the base, is approximately U-shaped in plan view, and is provided with two arms, which are pivoted to the base at their free end; said lever can thus oscillate with respect to the base in an open position and is further provided with known means for detachably fixing it adjacent to said base in a closed position.

A guide is rotatably supported between the two arms of the lever and has an approximately U-shaped transverse cross-section, a pawl-shaped element being pivoted between its wings.

When the lever is in the open position, the toothed band is inserted in the guide by a chosen extent and the teeth of said band engage the pawl-shaped element, which selectively prevents its retraction; once the chosen degree of advancement of the band with respect to the guide has been reached, the lever is moved to the closure position, further increasing the degree of advancement of the band with respect to the base and fastening to each other the two flaps of the shoe.

Although this known solution does not have the problem of the wear of the teeth of the band which can be observed in previously described known solutions, it has the drawback that in order to increase the degree of fastening of the two flaps the lever must first be returned to the open condition, thus temporarily loosening the fastening, with the risk for example of the foot slipping out; this is a considerable drawback, especially in the case of cycling shoes, which require the possibility to adjust the degree of fastening while racing.

Further, even this known type of closure device entails the disadvantage of not allowing selective retraction of the band during use, since by releasing the pawl-shaped element the tension on the band tends to make it retract in an uncontrolled manner with respect to the base.

### SUMMARY OF THE INVENTION

The aim of the present invention is to solve the above-mentioned problems, eliminating the drawbacks of the cited background art, by providing a closure device, particularly for a sports shoe, which maintains over time high reliability in the fastening of the flaps of the shoe.

Within this aim, an object of the invention is to provide a closure device which allows to achieve the chosen increase or decrease in the degree of fastening of the flaps of a shoe without the need to perform repeated readjustments thereof until the chosen fastening is achieved and without having to reduce temporarily the degree of fastening during its adjustment.

Another object is to provide a closure device which allows to adjust the degree of fastening of the flaps of a shoe during its use.

Another object is to provide a closure device which is structurally simple and has low manufacturing costs.

This aim and these and other objects, which will become better apparent hereinafter, are achieved by a closure device, particularly for a sports shoe, which comprises a toothed band, which can be rigidly coupled to a first flap of said shoe and can be associated slidingly with a base which can be rigidly coupled to a second flap of said shoe, said base comprising a first pawl-shaped element, which is provided with a first tip which can engage selectively, by way of the action of first elastic means, said toothed band in order to prevent its extraction in the direction for opening said first and second flaps, characterized in that the free ends of the arms of a lever are rotatably associated with said base at a pair of first pivots, said lever being approximately U-shaped in plan view, a second pawl-shaped element being supported rotatably between said arms at a second pivot which is axially offset with respect to said pair of first pivots toward said toothed band, said second pawl-shaped element being provided with a second tip which can engage said toothed band and is forced toward said base by second elastic means.

### BRIEF DESCRIPTION OF THE DRAWINGS

Further characteristics and advantages of the invention will become better apparent from the following detailed description of a particular but not exclusive embodiment thereof, illustrated by way of non-limiting example in the accompanying drawings, wherein:

FIG. 1 is a perspective view of a closure device according to the invention;

FIG. 2 is an exploded perspective view of the device of FIG. 1;

FIG. 3 is a plan view of the device of FIG. 1;

FIG. 4 is a sectional view, taken along the line IV-IV of FIG. 3;

FIG. 5 is a sectional view, similar to FIG. 4, of the device of FIG. 1 during the step for increasing the degree of fastening of the two flaps of a shoe.

### DESCRIPTION OF THE PREFERRED EMBODIMENTS

In the exemplary embodiments that follow, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

With reference to the figures, the reference numeral 1 designates a closure device, particularly for a sports shoe, such as for example a cycling shoe, a ski boot, a roller skate or an ice skate.

The device 1 comprises a toothed band 2, which can be rigidly coupled, at a first end 3, to a first flap 4 of the shoe; the toothed band 2 comprises a plurality of teeth 5, which are shaped, in a cross-section taken along a plane which is longitudinal with respect to the band 2, approximately like a right triangle, so as to form a rear surface 6, which is approximately perpendicular to the plane of arrangement of the toothed band 2, and an inclined surface 7, which is directed toward a second free end 8 of the toothed band 2.

The toothed band 2 can be associated slidingly with a base 9, which can be rigidly coupled to a second flap 10 of the shoe to be joined to the first flap 4 and advantageously has, in plan view, an approximately rectangular shape and is preferably flat or slightly arc-like.

Two first shoulders, designated respectively by the reference numerals 12a and 12b, protrude laterally to the base 9, approximately at right angles thereto and proximate to a first transverse end 11 thereof which is directed away from the first flap 4; said first shoulders are approximately mutually parallel, and two first mutually facing through holes 13a, 13b are formed therein respectively, said holes being arranged advantageously along an axis which lies transversely to the base 2; advantageously, a slot 14 is provided on at least one of the two first shoulders 12a or 12b.

Two approximately mutually parallel second shoulders, designated respectively by the reference numerals 16a and 16b, protrude laterally with respect to the base 9, approximately at right angles thereto and proximate to a second transverse end 15 thereof which is directed toward the first flap 4; two mutually facing second through holes 17a and 17b are provided respectively in said shoulders and are arranged advantageously along an axis which lies transversely to the base 2.

A first pawl-shaped element 18 is rotatably supported between the first shoulders 12a and 12b and is provided with a first tip 19, which is directed away from the first flap 4 and can engage selectively the toothed band 2 in order to prevent its extraction in the direction for opening the first and second flaps.

A third through hole 20 is formed transversely with respect to the first pawl-shaped element 18, and a pin or rivet 21 can be accommodated therein and is arranged with its ends in the first holes 13a and 13b, so as to rotatably couple the first pawl-shaped element 18 to the first shoulders 12a and 12b.

First elastic means are provided in order to force the first tip 19 of the first pawl-shaped element 18 toward the base 9 and are constituted for example by a first coiled spring 22, which is accommodated in an appropriately provided first seat, not shown in the accompanying figures, which is provided in the first pawl-shaped element 18 and is fixed by means of one of its ends to said pawl-shaped element and by means of its other end in the slot 14 formed in one of the two first shoulders 13a, 13b.

A lever 23 is rotatably associated with the base 9 and has an approximately U-shaped plan configuration so as to form a base 24 from which two arms, designated respectively by the reference numerals 25a and 25b, protrude approximately at right angles and in the opposite direction with respect to the toothed band 2, said arms being associated rotatably, at their free ends 26a and 26b, respectively with the second shoulders 16a and 16b.

Two first through openings, designated respectively by the reference numerals 27a and 27b, are formed at the free ends 26a and 26b of the arms 25a and 25b along an axis which coincides, during use, with the axis of the second holes 17a and 17b.

Two second through openings, designated respectively by the reference numerals 28a and 28b, are provided respectively proximate to the first openings 27a, 27b, in the region of the arms 25a, 25b comprised between said openings and the base 24; said openings are advantageously arranged along an axis which is parallel to, but further spaced from the base 9, the axis of the first openings 27a and 27b.

Advantageously, in at least one of the two arms 25a, 25b there is a slot 29 provided proximate to the second openings 28a, 28b of said arms.

Advantageously, the arms 25a, 25b are associated rotatably respectively with the second shoulders 16a and 16b by way of appropriate first pivots, designated respectively by the reference numerals 30a and 30b, which are fixed respectively in the second holes 17a and 17b and in the first openings 27a and 27b.

A second pawl-shaped element 31 is supported rotatably between the arms 25a, 25b of the lever 23 and is provided with a second tip 32, which is directed away from the first flap 4 and can engage the toothed band 2; a third opening 33 is provided transversely to said pawl-shaped element, and a second pivot 34 can be inserted therein; said second pivot can be fixed, by means of its ends, in the second openings 28a and 28b provided in the arms 25a, 25b; the second pivot 34 is thus axially offset with respect to the first pivots 30a and 30b toward the toothed band 2.

The second tip 32 of the second pawl-shaped element 31 is forced toward the base 9 by second elastic means, which are constituted for example by a second coiled spring 35, which can be accommodated in an appropriately provided second seat, not shown in the accompanying figures, which is formed in the second pawl-shaped element 31, and fixed with one of its ends to said second pawl-shaped element and with its other end, which is conveniently folded, in the slot 29 formed in one of the two arms 25a, 25b of the lever 23.

Advantageously, the center distance between the first openings 27a, 27b and the second openings 28a, 28b and/or the distance between the first and second tips are such that when the first tip 19 works in abutment against a tooth 5 the second tip 32 can be made affect an intermediate region of the inclined surface 7 of a different tooth 5 or vice versa.

In the particular embodiment shown, the distance of the second tip 32 of the second pawl-shaped element 31 from the first tip 19 of the first pawl-shaped element 18 is approximately equal to a preset noninteger multiple of the spacing of the teeth 5 of the toothed band 2; in this manner, while the first tip 19 is engaged with the rear surface 6 of one of the teeth 5, the second tip 32 abuts against the inclined surface 7 of a different tooth 5 and vice versa, while the second tip 32 is engaged with the rear surface 6 of one of the teeth 5, the first tip 19 abuts against the inclined surface 7 of a different tooth 5.

Advantageously, the center distance between the first openings 27a, 27b and the second openings 28a, 28b and the distance between the second tip 32 and the third opening 33 are such that the second tip 32 does not protrude beyond the second transverse end 15 of the base 9 for any position of the lever 23.

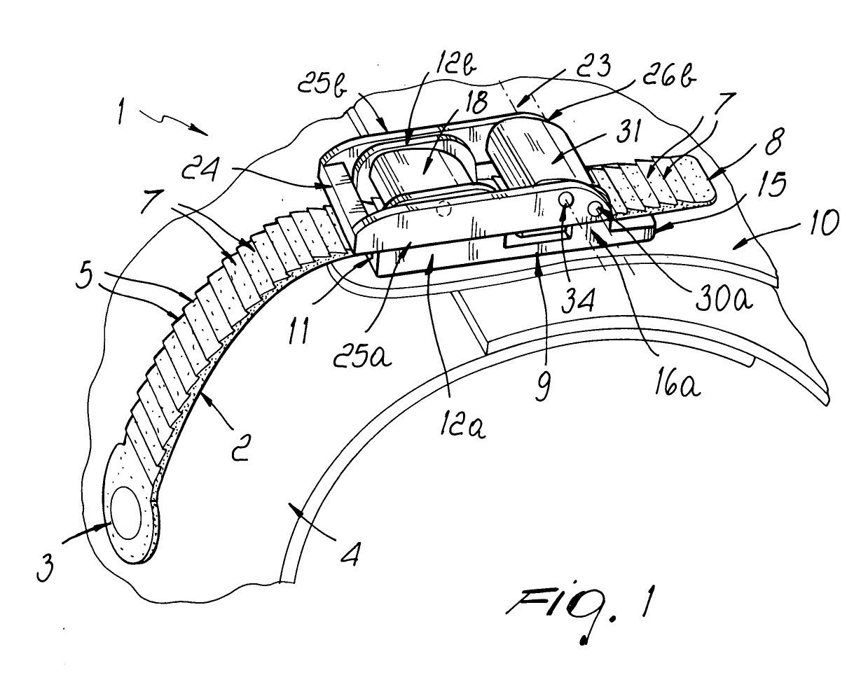

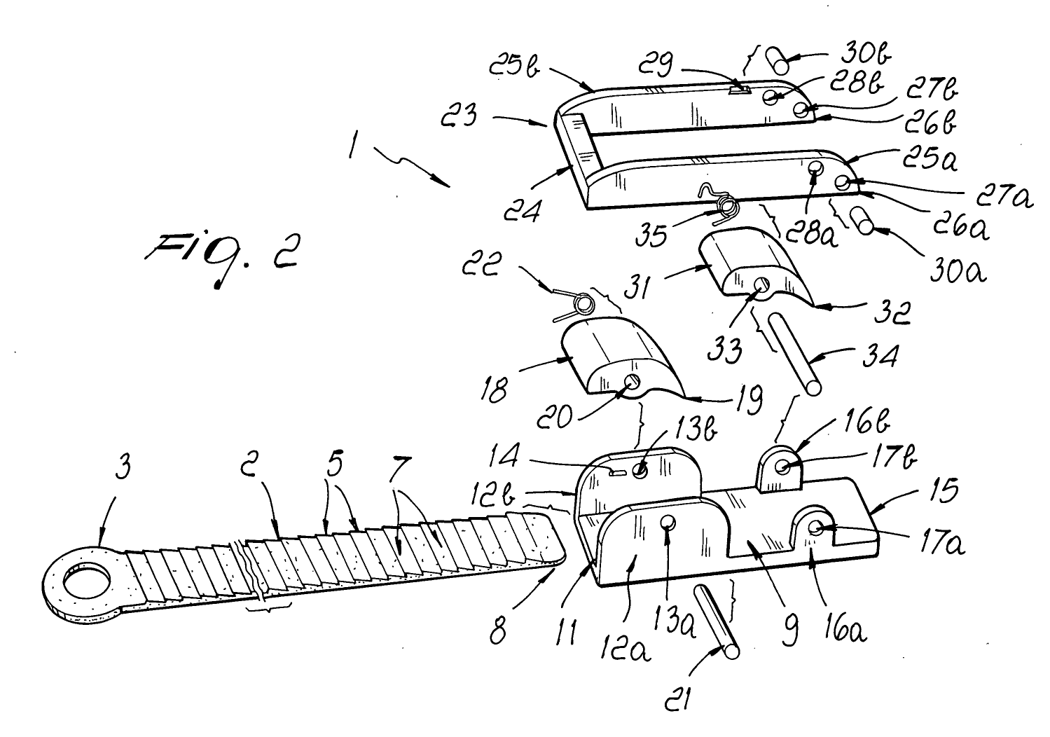

Operation is therefore as follows: with reference to FIG. 1, the second end 8 of the toothed band 2 is inserted in the base 9 at the first transverse end 11 thereof, until the tooth 5 of the toothed band 2 that lies closest to the second end 8 moves beyond the second tip 32 of the second pawl-shaped element 31; the toothed band 2 then is arranged between the two first shoulders 12a and 12b and between the two second shoulders 16a and 16b, below the first pawl-shaped element 18 and the second pawl-shaped element 31.

The first coiled spring and the second coiled spring respectively keep the first tip 19 and the second tip 32 of said first and second pawl-shaped elements pressed toward the toothed band 2.

By applying, as shown in FIG. 5, a traction to the base 24 of the lever 23 so as to move it away from the first transverse end 11 of the base 9, the lever 23 turns with respect to the base 9, and the second pivot 34, which supports the second pawl-shaped element 31, thus rotates about the axis of the second holes 17a, 17b; the second coiled spring 35 keeps the second tip 32 of the second pawl-shaped element 31 constantly pressed toward the toothed band 2, so that during the rotation of the lever 23 the second tip 32 abuts against the rear surface 6 of one of the teeth 5 of the toothed band 2.

Continuing with the rotation of the lever 23, the second tip 32 performs a translational motion parallel to the base 9 in the opposite direction with respect to the first transverse end 11, moving in said direction the toothed band 2 and thus achieving the advancement thereof with respect to the base 9.

During this advancement step, the second tip 32 maintains an almost constant angle of incidence on the tooth 5 of the toothed band 2 with which it is engaged, accordingly minimizing the wear of said tooth.

During the advancement of the toothed band 2, the first tip 19 of the first pawl-shaped element 18 engages in a ratcheting fashion, in contrast with the first coiled spring 22, the teeth 5 of the toothed band 2, without interfering with its advancement in the direction for fastening the first and second flaps.

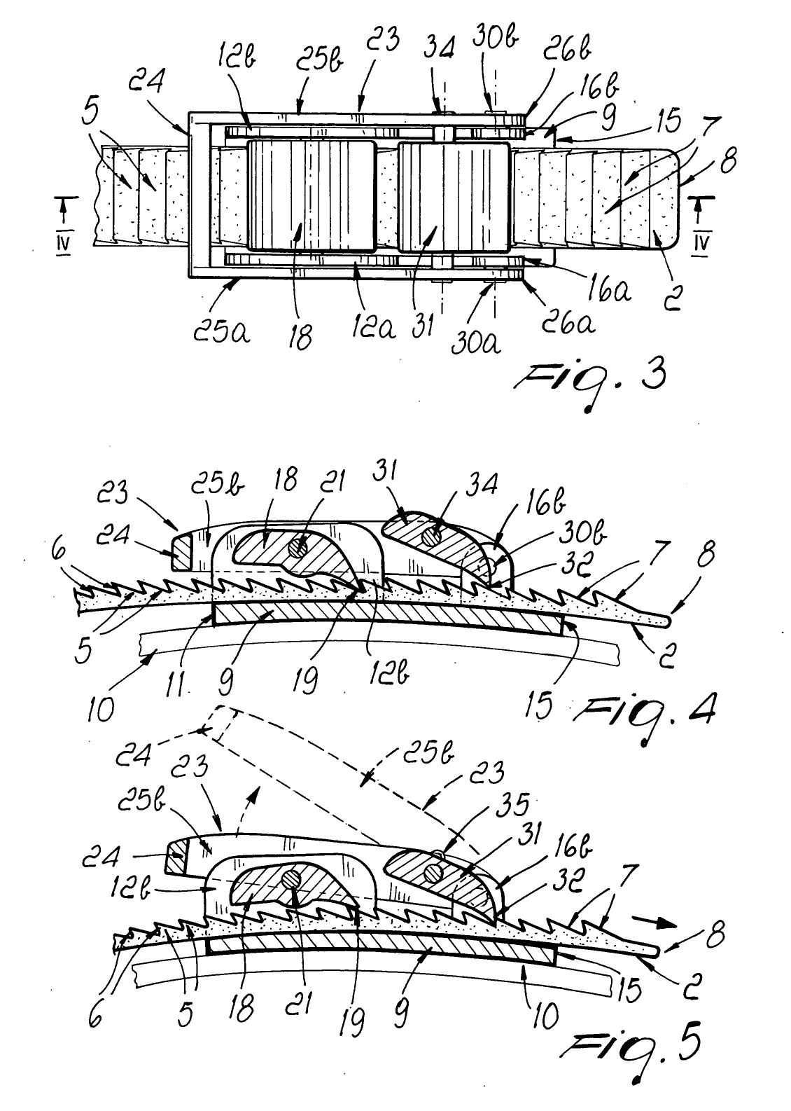

Once the chosen degree of fastening has been reached, the lever 23 can be released and returned, by way of the action of the second coiled spring 35, toward the base 9, thus moving into the condition shown in FIG. 4.

The first tip 19 of the first pawl-shaped element 18 engages the rear surface 6 of the tooth 5 of the toothed band 2 which is arranged directly downstream of the first tip 19, rigidly coupling the toothed band 2 in said position.

In this condition, the second tip 32 of the second pawl-shaped element 31 abuts against the inclined surface 7 of one of the teeth 5 of the toothed band 2.

By applying pressure to the end of the first pawl-shaped element 18 that lies opposite the first tip 19 thereof, the first tip 19 disengages from the toothed band 2.

Due to the very structure of the sports shoe, in particular if it is a boot or skate, and/or due to the possible presence of the foot of the user therein, the two flaps tend to move mutually apart, imparting to the toothed band 2 a tension in the direction for extracting it from the base 9; accordingly, the toothed band 2, by way of the action of said tension, retracts in the direction for extraction from the base 9 until the rear surface 7 of the tooth 5 thereof that follows the one previously engaged with the second tip 32 abuts against the second tip 32, locking the sliding of the toothed band 2.

In this condition, the first tip 19 of the first pawl-shaped element 18 abuts against the inclined surface 7 of the tooth 5 with the rear surface 6 of which it was previously engaged.

Likewise, by releasing the second pawl-shaped element 31, the toothed band 2 retracts with respect to the base 9 by an extent which is equal to the distance that separates the first tip 19 of the first pawl-shaped element 18 from the rear surface 6 of the tooth that follows the one with which the first tip 19 is engaged, stopping when the first tip 19 abuts against the rear surface 6.

Likewise, by alternately releasing the first and second pawl-shaped elements it is thus possible to achieve the retraction of the toothed band 2 by a chosen length, thus achieving the chosen reduction of the degree of fastening of the first and second flaps of the shoe.

In order to allow the complete extraction of the toothed band 2 from the base 9 it is necessary to simultaneously release the first and second pawl-shaped elements.

It has thus been found that the invention has achieved the intended aim and objects, a closure device particularly for a sports shoe having been provided which, by not having wear or having only minimal wear of the teeth of the toothed band, ensures that high reliability is maintained over time in the fastening of the two flaps of the shoe to which it is applied.

Further, the device according to the invention allows, even while using the shoe, to vary easily the degree of mutual fastening of the two flaps, even by a fraction of the length of a single tooth.

Moreover, since the device according to the invention allows to achieve the chosen retraction of the toothed band even while using the shoe, said device has an optimum application for example in shoes for cycling.

Moreover, the locking of the toothed band performed by the first and second pawl-shaped elements is very stable and solid, since said components can affect even the entire transverse extension of the toothed band.

Further, the production costs of the device according to the invention remain low, since it is provided only by means of components which are simple to manufacture and/or assemble.

The invention is of course susceptible of numerous modifications and variations, all of which are within the scope of the appended claims.

The materials used, as well as the dimensions that constitute the individual components of the invention, may of course be more pertinent according to specific requirements.

The various means for performing certain different functions need not certainly coexist only in the illustrated embodiment but can be present per se in many embodiments, including ones that are not illustrated.

The characteristics indicated as advantageous, convenient or the like may also be omitted or be replaced with equivalents.

The disclosures in Italian Utility Model Application No. TV2005U000053 from which this application claims priority are incorporated herein by reference.

What is claimed is:

1. A closure device, for a sports shoe having a first and a second flap, comprising: a base suitable to be rigidly coupled to the second flap of the shoe; a toothed band, which is rigidly coupleable to the first flap of the shoe and is further slidingly coupled with said base; first elastic means; a first pawl-shaped element supported on said base and provided with a first tip actuated by said first elastic means to engage selectively said toothed band in order to prevent extraction thereof in a direction of opening of said first and second flaps; first pivots; a U-shaped lever having arms with free ends that are rotatably connected with said base by way of said first pivots; a second pivot; second elastic means; and a second pawl-shaped element that is supported rotatably between said arms by way of said second pivot which is axially offset with respect to said first pivots toward said toothed band, and wherein said second pawl-shaped element is provided with a second tip which is engageable with said toothed band and is forced toward said base by said second elastic means.

2. The closure device of claim 1, comprising: two first mutually parallel shoulders that protrude laterally with respect to said base, at right angles thereto and proximate to a first transverse end of said base which is directed away from the first flap, two first holes being formed respectively in said shoulders along an axis which lies transversely to said base; two mutually parallel second shoulders protruding laterally to said base, at right angles thereto and proximate to a second transverse end thereof which is directed toward said first flap, two second holes being provided respectively in said second shoulders along an axis which lies transversely to said base; and wherein said lever is provided with a lever base from which said arms protrude at right angles and in an opposite direction with respect to said toothed band, and with two first openings formed at the free ends of said arms and having, during use, a same axis as said first holes, said free ends being rotatably coupled with said second shoulders by insertion of said first pivots in said second holes and in said first openings.

3. The closure device of claim 2, wherein said lever has two second openings formed proximate to said first openings, in a region of said arms that is comprised between said first openings and said lever base, and along an opening axis which lies transversely to said lever base.

4. The closure device of claim 3, wherein said second openings are arranged along said opening axis which is parallel, and spaced further from said lever base, with respect to the axis of said first openings.

5. The closure device of claim 4, wherein said second pawl-shaped element comprises a third opening provided transversely thereto, said second pivot being insertable in said third opening, said second pivot being engageable with ends thereof in said second openings provided in said arms.

6. The closure device of claim 1, wherein said toothed band comprises a plurality of teeth which are shaped, in a cross-section taken along a plane which is longitudinal thereto, like a right triangle, said teeth having each a rear surface, which is perpendicular to a plane of arrangement of said toothed band, and an inclined surface, which is directed toward said second flap, and wherein a center distance between said first and second openings and/or a distance between said first and second tips are such that while said first tip works in abutment against a tooth of said toothed band, said second tip arranges at an intermediate region of the inclined surface of a different tooth and vice versa.

7. The closure device of claim 6, wherein a distance of said second tip of said second pawl-shaped element from said first tip of said first pawl-shaped element is provided equal to a preset noninteger multiple of a spacing of said teeth of said toothed band.

8. The closure device of claim 5, wherein said first and second openings and said second tip and said third opening are provided with a center distance and respectively a distance therebetween such that said second tip does not protrude beyond said second transverse end of said base for any position of said lever.

9. The closure device of claim 5, wherein said first elastic means are constituted by a first coiled spring and said second elastic means are constituted by a second coiled spring accommodatable in an appropriately provided second seat which is formed in said second pawl-shaped element, said second coiled spring being fixed, at one of its ends, to said second pawl-shaped element and, at its other end, which is appropriately folded, in a slot formed within one of said arms of said lever, proximate to one of said second openings.
